(19) United States
(12) Patent Application Publication
(10) Pub. No.: US 2021/0133753 A1
(43) Pub. Date: May 6, 2021

(54) METHOD AND SYSTEM TO PREVENT FRAUD IN PAYMENT SYSTEMS TRANSITIONING TO MOBILE PAYMENT AND CHIP CARDS

(71) Applicant: Jack Shauh, San Diego, CA (US)

(72) Inventor: Jack Shauh, San Diego, CA (US)

(21) Appl. No.: 17/145,213

(22) Filed: Jan. 8, 2021

Related U.S. Application Data
(63) Continuation-in-part of application No. 15/642,291, filed on Jul. 5, 2017.
(60) Provisional application No. 62/959,154, filed on Jan. 9, 2020.

(51) Int. Cl. G06Q 20/40; G06Q 20/34

(52) U.S. Cl. CPC G06Q 20/4016; G06Q 20/34; G06Q 20/4093

(57) ABSTRACT

A payment system for reducing fraud is payment card transactions. The system includes a payment device coupled through a merchant to a payment network and a fraud prevention system coupling an issuing bank to the payment network. The fraud prevention system includes a transaction processing module and a monitor/detect module. The transaction processing module receives transaction messages from the payment network and sends transaction messages to the payment network from the issuing bank and provides transaction processing to approve or reject transactions. The monitor/detect module is coupled between the transaction module and a database module storing payment method data. The monitor/detect module compares established payment precedent of parties to a transaction to detect fraud and sends feedback to the transaction processing module.

### CROSS-REFERENCE TO RELATED APPLICATION

This application claims the benefit of U.S. Provisional Application No. 62/959,154, filed 9 Jan. 2020 and U.S. patent application Ser. No. 15/642,291, filed 5 Jul. 2017 which claims the benefit of U.S. Provisional Application No. 62/363,386, filed 18 Jul. 2016.

### FIELD OF THE INVENTION

This invention relates to smart card and mobile payment systems.

More particularly, the present invention relates to reducing fraud in transitioning to mobile payment and smart card systems use.

### BACKGROUND OF THE INVENTION

In the past, credit card use as a payment method included using the credit card number (i.e. primary account number (PAN)) either entered manually by the merchant or purchaser, or entered by swiping the magnetic stripe of the credit card for authorization. This old payment method led to high levels of fraud. Credit card numbers, counterfeit magnetic stripes and other information could be obtained by fraudulent users and used for purchases. The credit or debit payment industry has started to migrate from magnetic stripe cards to smart chip cards using the EMV (Europay, Master and Visa) protocols. When using an EMV card, the authentication of the card can be verified by using a cryptogram generated by the smart chip in the card. Meanwhile, mobile payment systems using mobile devices to make token based mobile payments as a platform are emerging. Mobile payment applications as a virtual credit/debit card are starting to be provided to mobile devices such as smart phones, tablets, watches and other wearable devices, and the like. Mobile payment systems currently include a few different payment schemes, such as Apple Pay, Android/Google Pay, etc. These new payment methods can provide better security by authenticating the card, or the device and even hiding the credit or debit card number, i.e. primary account number (PAN) using encryption or payment token.

While these new payment methods are starting to be adopted by customers and merchants, it will take time before they become pervasive. During the transition period between switching from using the old payment method, using credit and debit card numbers, and the new payments methods, using mobile payment and EMV cards, it will be necessary for customers and merchants to be able to use the old payment methods with the credit or debit card number and the new methods which are more secure. This is especially true for the online merchants that traditionally only take credit or debit card number, i.e. PAN, for processing the transaction. Therefore, fraudulent transactions generally avoidable by using the new payments will still easily occur due to the possible use of the old methods. This invention provides new solutions for preventing fraudulent transactions in this transition period from the old payment methods to the new payment methods.

It would be highly advantageous, therefore, to remedy the foregoing and other deficiencies inherent in the prior art.

An object of the present invention is to provide a method and system for reducing the occurrences of fraud in payment systems.

### SUMMARY OF THE INVENTION

Briefly, to achieve the desired objects and advantages of the instant invention, provided is a payment system. The payment system includes a payment device coupled through a merchant to a payment network and a fraud prevention system coupling an issuing bank to the payment network. The fraud prevention system includes a transaction processing module, a non-transitory computer-readable storage medium and a monitor/detect module. The transaction processing module receives transaction messages from the payment network and sends transaction messages to the payment network from the issuing bank and provides transaction processing to approve or reject transactions. The monitor/detect module is coupled between the transaction module and a database module storing payment method data. The non-transitory computer-readable storage medium carries instructions that when effectuated by the monitor/detect module result in the monitor/detect module comparing established payment precedent of parties to a transaction to detect anomalies indicating fraud and sending feedback to the transaction processing module.

Also provided is a card payment method with fraud detection. This method includes providing a payment device coupled through a merchant to a payment network. A fraud prevention system is provided, coupling an issuing bank to the payment network. The fraud prevention system includes a database storing payment methods accepted by the merchant, a monitor/detect module coupled between a transaction module and the database module and a non-transitory computer-readable storage medium having instructions that when effectuated by the monitor/detect module result in the monitor/detect module comparing established payment precedent of parties to a transaction to detect anomalies indicating fraud and sending feedback to the transaction processing module. A payment card is provided which is capable of both old payment methods and new payment methods. A payment transaction is made with the payment card using the payment device and a payment method. The payment method is one of an old payment method and a new payment method. An authorization request message is sent from the payment device to the payment network, the authorization request message including information on the payment method. The authorization request message is forwarded from the payment network to the fraud prevention system of the issuing bank. Effectuating the instruction carried by the non-transitory computer-readable storage medium with the monitor/detect module, including comparing the payment method used in the payment transaction to the payment methods accepted by the merchant; and sending an authorization response to the payment network, the authorization response being one of an approval and a rejection, an approval when the payment method used in the payment transaction is a new payment method, an approval when the payment method used in the payment transaction is an old payment method and the merchant does not accept a new payment method supported by the payment card, and a rejection if the payment method is an old payment message and the merchant accepts a new payment method supported by the payment card.

### BRIEF DESCRIPTION OF THE DRAWINGS

The foregoing and further and more specific objects and advantages of the instant invention will become readily apparent to those skilled in the art from the following detailed description of a preferred embodiment thereof taken in conjunction with the drawings, in which:

FIG. 1 is a schematic of the message exchange between elements of a payment system and a user;

FIG. 2 is a schematic of the message exchange between elements of the payment system according to the present invention;

FIG. 3 is a schematic of the message exchange between elements of the payment system with an alert function;

FIG. 4 is simplified block diagram of a fraud prevention system provided to an issuing bank;

FIG. 5 is schematic example of incoming authorization request messages;

FIG. 6 is an example of database tables with transaction information;

FIG. 7 is a flow chart of the effectuation of instructions from the non-transitory computer-readable storage medium as performed by the monitor/detect module; and

FIG. 8 is an example of another form of a database table with transaction information.

### DETAILED DESCRIPTION OF THE PREFERRED EMBODIMENTS

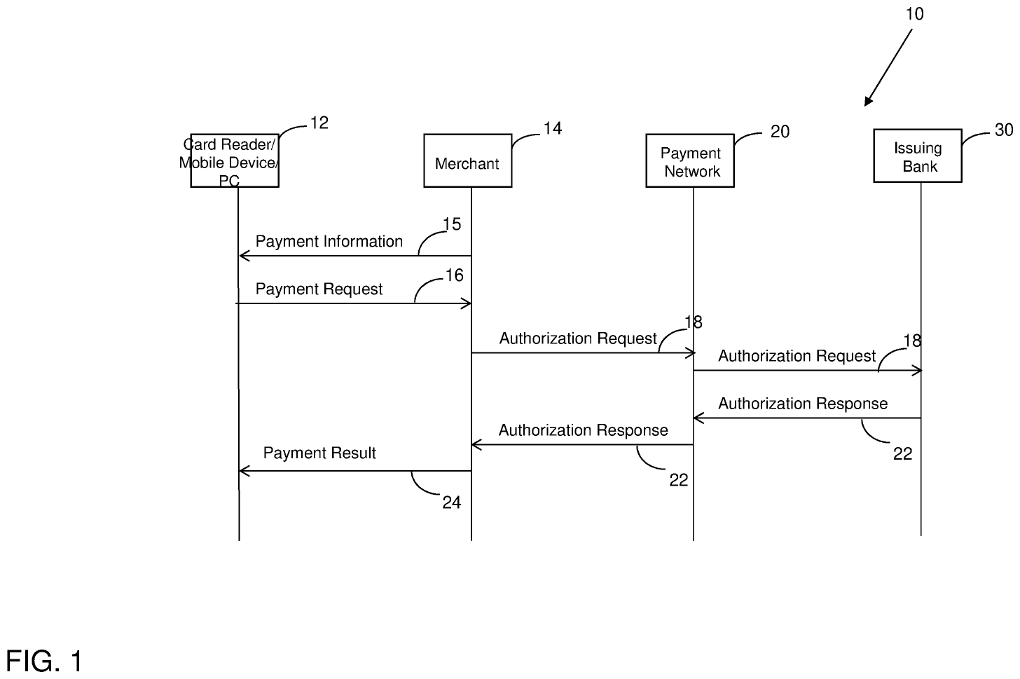

Turning now to the drawings in which like reference characters indicate corresponding elements throughout the several views, attention is first directed to FIG. 1 which illustrates an example of a conventional payment card payment transaction flow of a payment system 10. It will be understood that payment card as used in this specification is defined as a credit/debit card, and includes virtual credit/debit cards as used in mobile payment systems. A customer uses a credit or debit card (magnetic stripe or EMV based) on a payment device 12, such as a card reader, mobile device or PC to pay for a purchase with a merchant 14. Merchant 14 can be a brick-and-mortar store or an online store. Merchant 14 sends a payment information message 15 to payment device 12. Payment information message 15 includes payment information such as payment amount, currency code, and the like. Payment device 12 sends a payment request message 16 to merchant 14. This is accomplished in a variety of methods, broken into two groups, old payment methods and new payment methods. An old payment method requires a swipe of the magstripe or for the customer or merchant to manually input a credit card or debit card number via payment device 12 such as when a PC is employed and the information is manually input into a webpage. A new payment method is when payment device 12 is a card reader which can interface with an EMV Card to exchange data. Another new payment method is when the payment device is a mobile device using a mobile application to submit payment requests to the merchant via a mobile device or another PC device. Payment request message 16 can include the credit/debit card number, expiration date, transaction amount, etc. If an EMV card or mobile payment is used, security procedures are generally used, such as including an application cryptogram to authenticate the card, mobile device and message, and ciphering data in the message. If this is token based method, e.g. Apple Pay, Android/Google Pay, and the like, then the mobile payment will only provide an encrypted token (token is a substitute PAN) and token cryptogram. When merchant 14 receives payment request message 16, merchant 14 generates an authorization request message 18. Authorization request message 18 is sent to a payment network 20 (e.g., consisting of payment gateway, acquiring bank, brand network, token service provider (TSP), etc.). Payment network 20 forwards authorization request message 18 to an issuing bank 30 which must approve or reject the transaction. Payment network 20, particularly if it is a TSP, can detokenize the payment token, in the authorization request message 118 to retrieve the real card number (PAN), and include payment token (or Device PAN), token cryptogram, and real card number (PAN) in authorization request 18 for Issuing Bank 30 to approve. Issuing Bank 30 receives authorization request message 18, specified in ISO (International Organization for Standardization) 8583 standards, from Merchant 14 via Payment Network 20. On approving the transaction, issuing bank 30 replies to payment network 20 with an authorization response message 22, specified in ISO8583 standards. Payment network 20 forwards authorization response message 22 to merchant 14. Merchant 14 replies with a payment result 24 to payment device 12. This process illustrates both old payment methods and new payment methods currently used in credit card and debit card transactions. While some transactions may be secure (new payment method), others may not be (old payment method), but each can potentially be employed.

For ease in reference, the old payment methods considered can be, but not limited to:
Method 1: Magnetic stripe card at POS terminal.
Method 2: Manually entering card number at online store.

The new payment methods can be, but not limited to:
Method 3: EMV IC card in which application cryptogram is included. The application cryptogram is used to authenticate the card.
Method 4: Token based mobile payment, such as Apple Pay, Android/Google Pay, etc. in which a substituted card number, i.e. payment token (token is a substitute Primary Account Number (PAN) or called Device PAN) is stored at the mobile device for payment. In payment transaction, the payment token and token cryptogram, e.g. based on 3D-Secure, are provided. The payment token can avoid the real card number being sent over the Internet. A token cryptogram is used to authenticate the card.

In the method and system of the present invention, card issuing bank 30 can reduce fraud by keeping records of the customer's payment habits, specifically whether the customers payment card is an EMV card and whether the customer uses mobile payment. Issuing bank 30 also maintains records on what type of payment method a merchant accepts and whether the customer can use that payment method. If the customer uses an EMV credit or debit card or mobile payment method X (new payment method 3 or 4) at a particular merchant that accepts EMV card or mobile payment method X, then the authorization is accepted. However, if the actual transaction is submitted by using the credit or debit card number (old payment method 1 or 2) to pay rather than using EMV card or mobile payment method X when available to both parties, the transaction is rejected. Thus, if using a new payment method is possible, and issuing bank 30 does a comparison and knows it is possible, an old payment method using a credit card number submitted to the POS terminal of the brick-and-mortar store or the web of the online store of the merchant is suspect. Therefore, card issuing bank 30 can detect such an irregularity and reject the transaction. If the customer's new payment method is not accepted by the merchant, the issuing bank will approve an old payment method since that method is the only possible method.

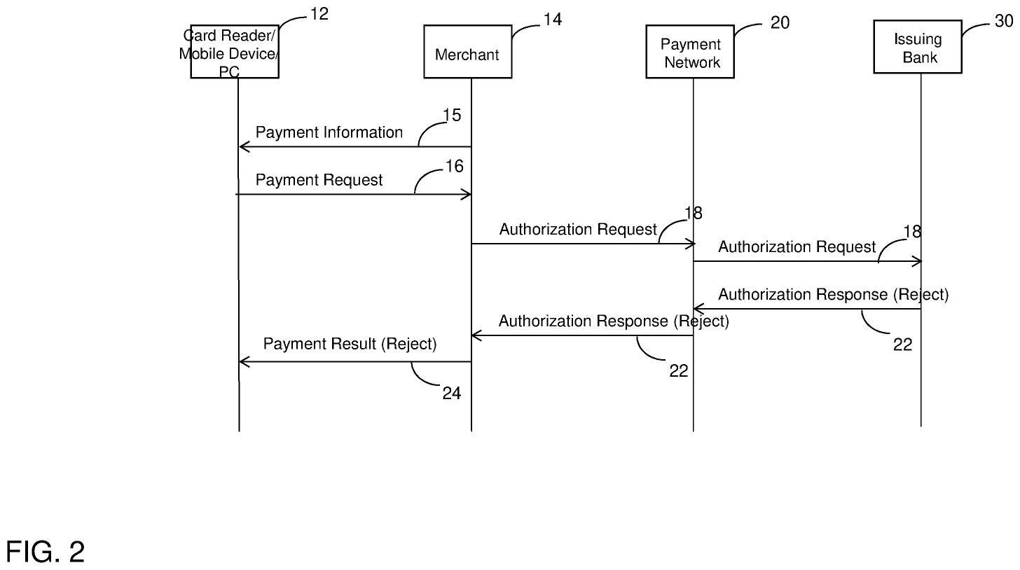

Referring to FIG. 2, a message flow according to the method and system of the present invention is illustrated. A customer intends to use a payment card to pay for the purchase with merchant 14, which can be a brick-and-mortar store or an online store. Merchant 14 sends payment information message 15 with payment amount, currency code, etc. to payment device 12. At this point several payment methods can be employed, depending on payment device 12 which include old payment methods such as: entering the card number on payment device 12 (method 2 on PC or mobile device); reading the magnetic stripe card on payment device 12 (method 1 with card reader of POS terminal); or new payment methods such as: reading IC card on payment device 12 (method 3 using the card reader of POS terminal or mobile device); paying with a mobile device using payment device 12 (method 4 using mobile payment via POS terminal); and purchasing on PC and paying and/or authorizing with payment device 12 (method 4 using mobile device using mobile payment). Payment device 12 sends payment request message 16 to merchant 14 to pay. Payment request message 16 can include the credit/debit card number, expiration date. When merchant 14 receives payment request message 16, merchant 14 generates an authorization request message 18. Authorization request message 18 is sent to a payment network 20 (e.g., consisting of payment gateway, acquiring bank, brand network, token service provider, etc.). Payment network 20 forwards authorization request message 18 to an issuing bank 30 which must approve or reject the transaction. In addition, payment network 20 passes data elements related to a payment method used, such as specific mobile payment method X, and a primary account number (i.e. PAN) received from merchant 14. Issuing bank 30 knows that the credit/debit account has EMV card or mobile payment and merchant 14 is capable of accepting EMV card and/or the mobile payment method X that the customer can use. Issuing bank 30 detects that the transaction is submitted by the merchant 14 only with the credit/debit card number, namely PAN (Primary Account Number). Issuing bank 14 rejects the transaction and replies to payment network 20 with authorization response message 22. In this case, authorization response message 22 is a rejection of the transaction. Issuing bank 30 knows that the account has EMV card by previous card activation process or mobile payment by previous registration process. Payment network 20 forwards authorization response message 22 rejecting the transaction to merchant 14. Merchant 14 sends payment result 24 to payment device 12, rejecting the transaction. Authorization request message 18 and authorization response message 22 are based on the ISO 8583 messages, e.g. authorization request and authorization response. Issuing bank 30 knows the capability of merchant 14 to accept EMV card or mobile payment by received authorization request message 18 (e.g. Message type indicator=0100 in decimal digits). Furthermore, issuing bank 30 can learn from the payment methods of the previous transactions of this merchant, e.g. previous authorization request messages 18.

Alternatively, the issuing bank may send an alert to the customer while the transaction is approved (or rejected). To turn on the alert messaging, the customer logs into issuing bank's website to enable this option.

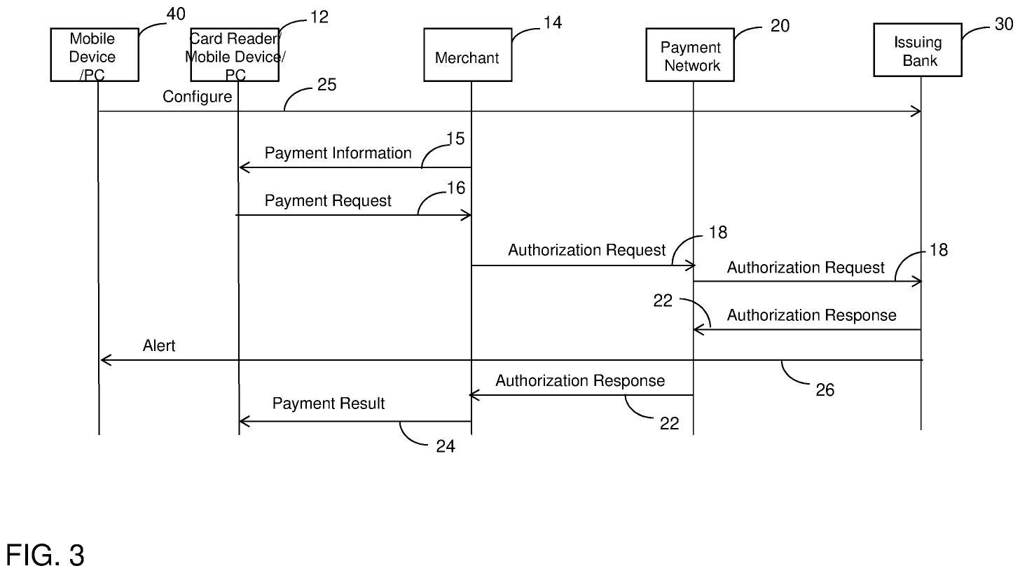

Turning now to FIG. 3, another message flow according to the method and system of the present invention is illustrated. The customer uses a web browsing capable device 40 such as a mobile device or PC to log in to a website to configure 25 a transaction with issuing bank 30. The configuration of the transaction with issuing bank 30 includes selecting an alert option when the credit or debit card number (i.e. PAN) is used for payment instead of using EMV card or mobile payment. Merchant 14 sends payment information message 15 with payment amount, currency code, etc. to payment device 12. At this point several payment methods can be employed, depending on payment device 12 which include old payment methods such as: entering the card number on payment device 12 (PC or mobile device); reading the magnetic stripe card on payment device 12 (card reader of POS terminal); or new payment methods, such as: reading IC card on payment device 12 (the card reader of POS terminal or mobile device); paying with a mobile device using payment device 12 (mobile payment via POS terminal); and purchasing on PC and paying and/or authorizing with payment device 12 (mobile device using mobile payment). Payment device 12 sends payment request message 16 to merchant 14 to pay. Payment request message 16 can include the credit/debit card number, expiration date. When merchant 14 receives payment request message 16, merchant 14 generates an authorization request message 18. Authorization request message 18 is sent to a payment network 20 (e.g., consisting of payment gateway, acquiring bank, brand network, token service provider, etc.). Payment network 20 forwards authorization request message 18 to an issuing bank 30 which must approve or reject the transaction. In addition, payment network 20 passes data elements identifying the payment method used, such as a specific mobile payment method X, and a primary account number (i.e. PAN) received from the Merchant. Issuing bank 30 detects that the customer has enabled the alert service for notification if only a credit/debit card number to pay instead of EMV Card or mobile payment. Issuing bank 30 also knows that merchant 14 is capable of accepting EMV card and mobile payment brand method X that the customer can use. Issuing bank 30 can approve or reject the transaction and replies to payment network 20 with authorization response message 22. Issuing bank 30 also sends an alert message 26 to web browsing capable device 40, e.g. SMS/MMS, email, push notification, or phone call with alert message. Payment network 20 returns with authorization response message 22 to merchant 14. Merchant 14 then sends payment result 24 to payment device 12.

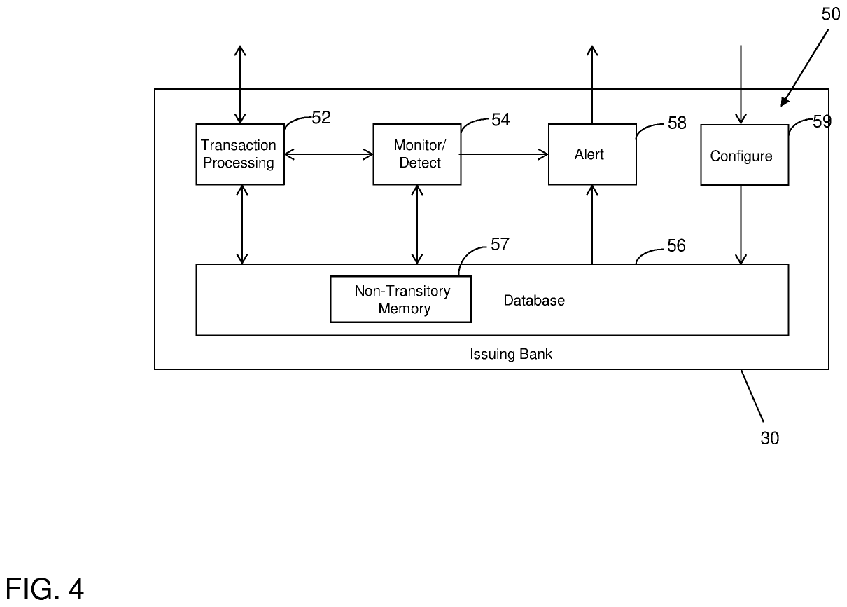

Turning now to FIG. 4, a fraud prevention system, generally designated 50 is provided at issuing bank 30 to limit the unsecured transactions and effectuate the previously described message flows. A transaction processing module 52 provides the credit/debit card transaction processing to approve or reject credit/debit card transactions and receive or reply with transaction messages described previously. A monitor/detect module 54 provides fraud monitoring and detecting functions as described previously. For example, monitor/detect module 54 can receive the method of payment (e.g. old method with credit/debit number or new method with tokenization and the like), use the merchant payment capability (support EMV card or mobile payment) and customer account payment capability (EMV card or mobile payment) in a comparison with established payment precedent to detect fraud. Monitor/Detect module 54 receives the method of payment from transaction processing module 52 and receives the payment capability of merchant 14 and customer account from a database module 56. Once fraud is detected, monitor/detect module 54 provides feedback to transaction processing module 52 to reject the transaction. Monitor/Detect module 54 also stores transaction monitor or detect history information per credit/debit card account in database 56. An alert module 58 sends alert message 26 to the customer, e.g. SMS, MMS, email, or phone call. Alert module 58 is enabled by a configure module 59 as to whether or not alert service is desired. Configure module 59 allows the credit/debit card holder to select to receive alert message 26, enabling alert module 58 when the credit/debit card number is used for a payment transaction (old method) instead of EMV Card, or mobile payment method X when the merchant is capable of accepting EMV card and mobile payment method X. Database module 56 not only stores each card holder's account information, credit balance, credit/debit card payment capability but also stores each merchant's payment acceptance capability which may be learned from payment network 20 or an acquiring bank. In addition, database module 56 stores the status of enabling or disabling alert service for that credit/debit card account. Database module 56 includes a non-transitory computer-readable storage medium 57 having instructions which, responsive to being executed by a processor operating Monitor/Detect module 54, cause Monitor/Detect module 54 to operate and follow a process as will be discussed presently. Non-transitory computer-readable storage medium 57 can take on a variety of forms. For instance, medium 57 may take the form of program code (i.e., instructions) embodied in concrete, tangible, storage media having a concrete, tangible, physical structure. Examples of tangible storage media include floppy diskettes, CD-ROMs, DVDs, hard drives, or any other tangible machine-readable storage medium (computer-readable storage medium). Thus, computer-readable storage medium 57 is non-transitory, is not a signal, is not a transitory signal, and is not a propagating signal. Medium 57 described herein is an article of manufacture. The hardware of system 50 operates under the control of a standard operating system maintained by a memory associated with system 50, enabling a computer processor to execute instructions from medium 57 to effectuate operations described with particularity in this disclosure.

The fraud detection method and apparatus of the present invention is primarily used in situations where the merchant can accept new payment methods and a customer can also use the new payment methods for a specific card number also referred to as PAN. The possibility of fraud can be detected in the following cases by example:

Case 1

Token based mobile payment method (new payment method 4) is accepted at a merchant and can be provided by a card number used by the customer, but the payment method actually used is the old payment method of manually entering the card number at the merchant (method 2).

Case 2

EMV IC card at POS payment method (new payment method 3) is accepted at a merchant and can be provided by a card number used by the customer, but the payment method actually used is the old payment method of using the magnetic stripe at POS at the merchant (method 1).

Case 3

Token based mobile payment method (new payment method 4) is accepted at a merchant and can be provided by a card number used by the customer, but the payment method actually used is the old payment method of magnetic stripe at POS at the merchant (method 1).

The above cases can imply that a card number used by a customer may be stolen and Issuing Bank 30 can reject the transaction, or alert the card number holder followed by more authentication of the transaction, e.g. multi-factor authentication.

Different payment methods can include different data elements and setting of values in the ISO8583 authorization request message 18. For example, data element (Field 22) is POS entry mode which has 3 subfields of which subfield 1 is PAN Entry Mode. PAN Entry Mode may be set to a specific value depending on the payment method:
PAN Entry Mode=02 for magnetic stripe card at POS payment method.
PAN Entry Mode=01 for manually entering card number at online store payment method
PAN Entry Mode=05 or 07 for EMV IC card at POS
PAN Entry Mode=81 for token based mobile payment method, e.g. Apply Pay, Android/Google Pay, in some network service provider, although there is no unified way of setting.

The ISO8583 authorization request message 18 can include other data elements for the related information used in this invention. Data elements used are shown in Table 1:
Primary Account Number (PAN) data element (Field 2) are required for all the payment methods. But in addition:
Data element (Field 55) contains Application Cryptogram for the EMV IC card
For example, Data Element Fields 120-127 (reserved for private use) contains payment token (Device PAN) and/or related fields, e.g. token cryptogram.

TABLE 1
Data elements for payment methods

| | | Data element | |
|---|---|---|---|
| | | (Field 22) | |
| | | Point of Service | |
| No. | Payment method | (POS) entry mode | Other data elements |
| 1 | Magnetic stripe | Subfield 1 PAN | Data element |
| | at POS | Entry Mode = | (Field 2) includes |
| | | 02 (Magnetic | Primary Account |
| | | Stripe Read) | Number (PAN) |
| 2 | Manually entering | Subfield 1 PAN | Data element |
| | card number at | Entry Mode = | (Field 2) includes |
| | online store | 01 (Manual | Primary Account |
| | | Entry) | Number (PAN) |
| 3 | EMV IC card at | Subfield 1 PAN | Data element |
| | POS | Entry Mode = | (Field 2) includes |
| | | 05 (Chip Card) | Primary Account |
| | | or 07 (Contactless | Number (PAN); |
| | | Chip Card) | and |
| | | | Data element |
| | | | (Field 55) includes |
| | | | Application |
| | | | Cryptogram |
| 4 | Token based | For example, | Data element |
| | mobile payment, | Subfield 1 | (Field 2) includes |
| | e.g. Apply Pay, | PAN Entry | Primary Account |
| | Android/Google | Mode = 81 | Number (PAN); |
| | Pay | | and |
| | | | for example, Data |
| | | | Element Fields |
| | | | 120−127 (reserved |
| | | | for private use) |
| | | | includes payment |
| | | | token (or |
| | | | Device PAN) and/or |
| | | | related fields, e.g. |
| | | | token cryptogram |

Authorization request can be used to determine the payment method used. Table 2 shows the rules.

TABLE 2
Condition to determine payment method

| No. | Payment method | Condition to determine this payment method |
|---|---|---|
| 1 | Magnetic stripe | Subfield 1 PAN Entry Mode = 02 |
| | at POS | (Magnetic Stripe Read) |
| 2 | Manually entering | Subfield 1 PAN Entry Mode = 01 |
| | card number at | included; and neither Application |
| | online store | Cryptogram nor payment token or |
| | | related fields, e.g. token cryptogram |
| | | being included, e.g. |
| | | in Field 120-127 |
| 3 | EMV IC card | Subfield 1 PAN Entry Mode = |
| | at POS | 05 (Chip Card) or 07 |
| | | (Contactless Chip Card); and/or |
| | | Application Cryptogram |
| | | (Field = 55) being included |
| 4 | Token based | Subfield 1 PAN Entry Mode, |
| | mobile payment, | e.g. = 81; and/or payment |
| | e.g. Apply Pay, | token (or Device PAN in Apple |
| | Android/Google | Pay, Google Pay) and/or related |
| | Pay | fields, e.g. token cryptogram being |
| | | included, e.g. in Field 120-127 |

Authorization request message 18 can indicate transaction from a merchant using Card Acceptor Identification Code (CAIC) (i.e., Data Element Field 42 in ISO 8583) or from a terminal of a merchant using a combination of Card Acceptor Identification Code and Card Acceptor Terminal Identification (CATI) (i.e., Data Element Field 41 in ISO 8583). CAIC or CAIC+CATI (or even CATI alone) can be included in the authorization request message 18 to identify a particular merchant terminal or merchant server.

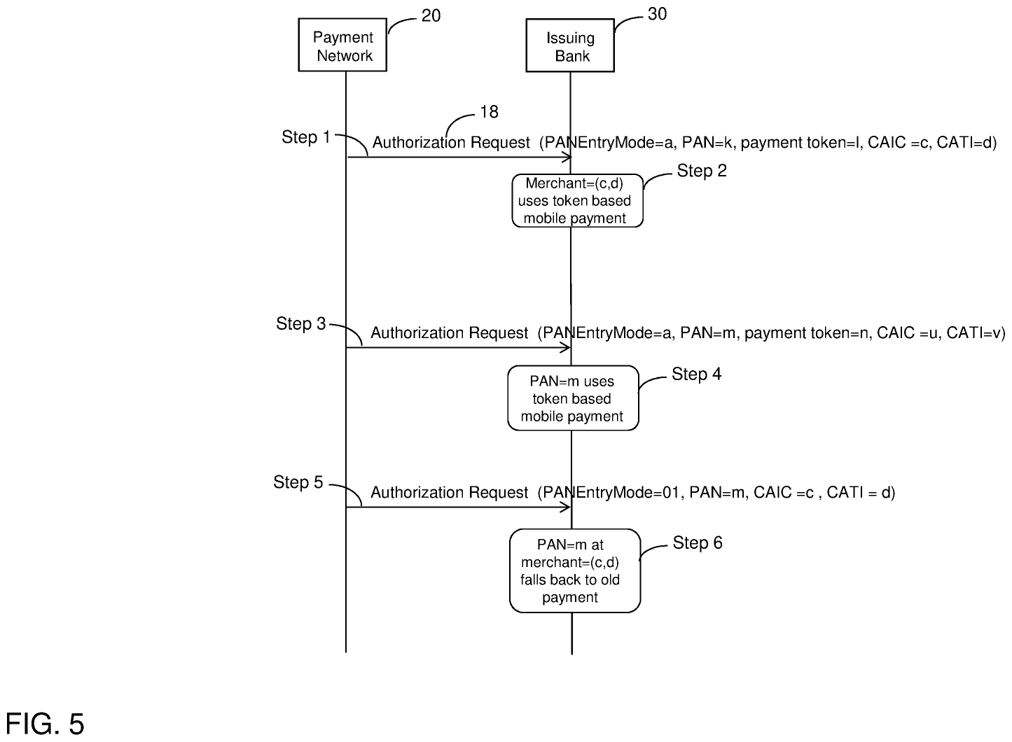

Turning now to FIG. 5, an example of message flow resulting from the instructions of non-transitory computer-readable storage medium 57 responsive to being executed by a processor operating Monitor/Detect module 54 is illustrated. FIG. 5 shows one case of fraud detection, i.e. case 1: Token based mobile payment method (new payment method 4) is accepted at a merchant and can be provided by a card number used by the customer, but the payment method used is the old payment method of manually entering card number (method 2). However other cases are similar.

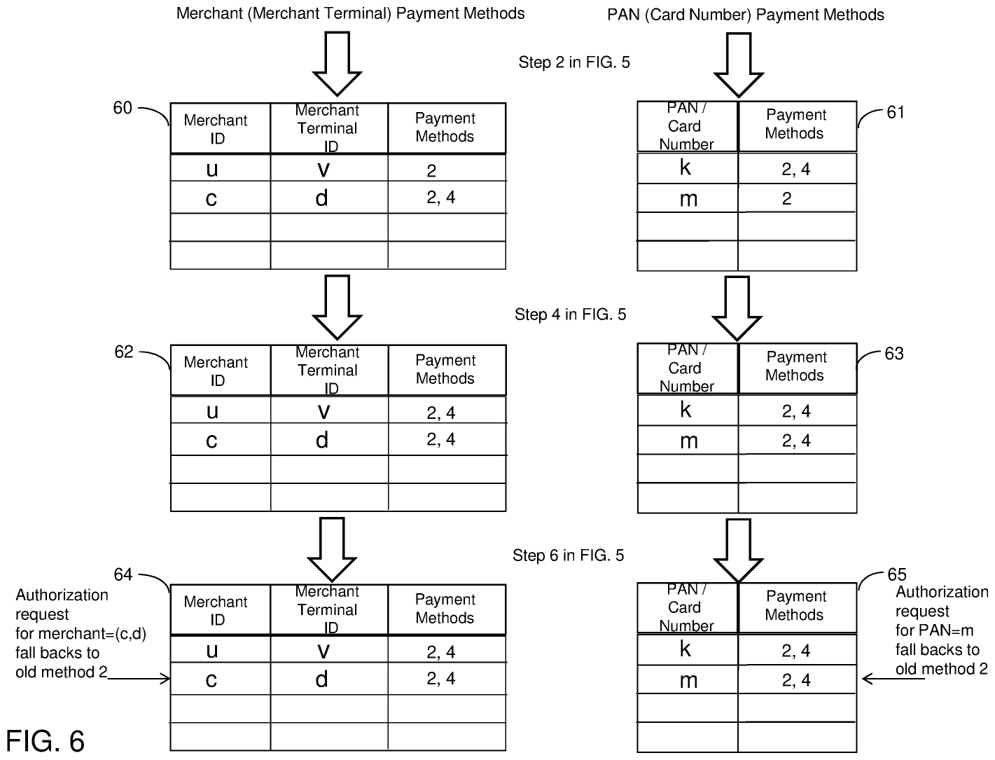

Still referring to FIG. 5, with additional reference to FIG. 6, which illustrates, in tablature, an example of the information collected by system 50 from the authorization request and stored in database 56, messaging includes the following plurality of steps. Step 1 includes Issuing Bank 30 receiving an authorization request with a unique POS terminal PAN entry mode=a (e.g. a=81) for the new payment method of token based mobile payment, PAN=k, payment token=l, Card Acceptor Identification Code=c, Card Acceptor Terminal Identification=d.

Step 2: Step 1 indicates that merchant (CAIC=c, CATI=d) uses the new payment method of token based mobile payment. Issuing bank 30 updates this information of merchant, i.e. CAIC=c, CATI=d in database 56 as shown in table 60 of FIG. 6 after step 2, where payment methods of merchant (CAIC=c, CATI=d) has payment method 4 (token based mobile payment) added thereto.

Step 3: Issuing Bank receives another authorization request with a unique POS terminal PAN entry mode=a (e.g. a=81) for the new payment method, PAN=m, payment token=n, Card Acceptor Identification Code (CAIC)=u, Card Acceptor Terminal Identification (CATI)=v.

Step 4: Step 3 indicates that the card number PAN=m starts to use new payment method of token based mobile payment. Issuing bank updates this information of this PAN=m in the database as shown in table 63 of FIG. 6.

Step 5: Issuing Bank receives yet another authorization request with PAN=m, Card Acceptor Identification Code (CAIC)=c, Card Acceptor Terminal Identification (CATI)=d. The authorization request has POS terminal PAN entry mode=01 (i.e. Manual) and does NOT include application cryptogram and does NOT include payment token and related fields, e.g. token cryptogram.

Step 6: Step 5 implies that the card payment falls back to the old method of manually entering the card number although this merchant and this card number can provide new payment method of token based mobile payment. This causes an alert for this transaction.

Note in Step 4: Although issuing bank may already know that mobile device has registered with token based mobile payment, but the actual fraud detection may start from when customer really uses token base mobile payment.

Referring specifically to FIG. 6, an example of a database to store records for the payment methods of the merchants and card numbers is shown. The database includes two parts, merchant data and card number (PAN) data. The merchant data includes merchant ID and merchant terminal ID and payment methods used and accepted. The card number data includes the PAN (or card number) and the payment methods used. Looking at the example in FIG. 6, after Step 2 of FIG. 5, database 56 gets updated that merchant Id (CAIC)=c and terminal Id (CATI)=d can use new payment method of token based mobile payment (method 4) as shown in table 60 of FIG. 6. After Step 4 of FIG. 5, database 56 gets updated that PAN=m can use new payment method of token based mobile payment (method 4) as shown in table 63 of FIG. 6. After step 6 of FIG. 5 an alert is triggered because the transaction falls back to old payment method of manually entering card number (method 2), although the merchant Id (CAIC)=c and terminal Id (CATI)=d used new payment method of token based mobile payment and PAN=m used new payment method of token based mobile payment.

Alternatively in FIGS. 5 and 6, only merchant Id (i.e. CAIC) is used and not merchant terminal Id (i.e. CATI). Or alternatively, only merchant terminal Id (i.e. CATI) is used and not merchant Id (i.e. CAIC). FIGS. 5 and 6 can also apply for fallback for other cases: from token based mobile payment (method 4) to magnetic stripe at POS (Method 1), or from EMV IC card at POS payment method (method 3) to magnetic stripe at POS (Method 1).

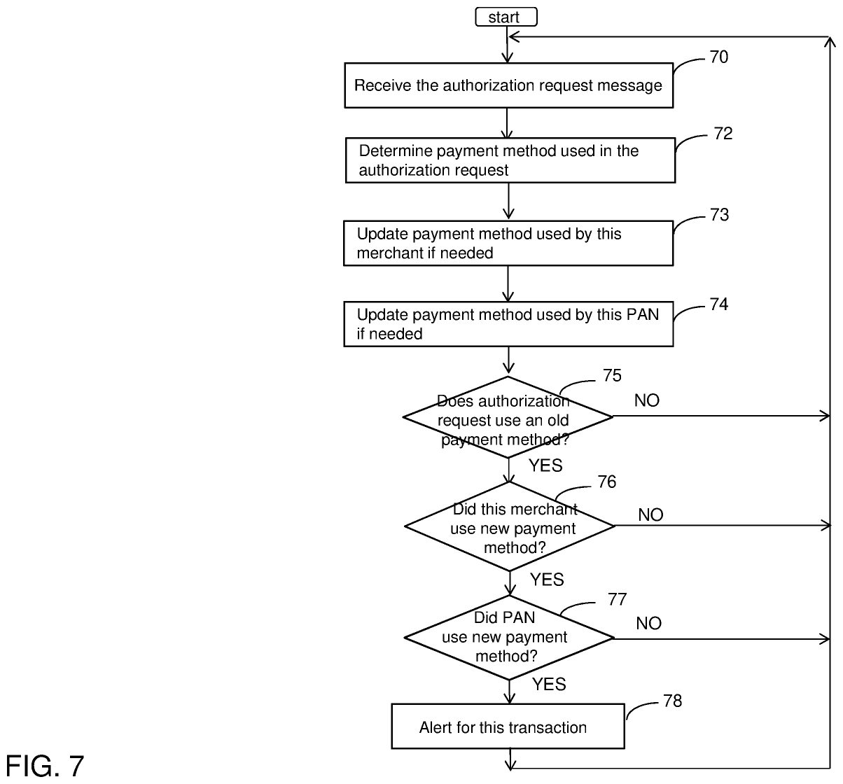

Turning now to FIG. 7, a generalized flow chart of the operation performed by the hardware of system 50 and particularly monitor/detect module 54 to effectuate the instructions from non-transitory computer-readable storage medium 57 is shown for a transaction. The processing flow starts from receiving 70 the authorization request message 18 carrying the card number, merchant identification, payment method used, etc. The payment method used by the authorization request message 18 is determined 72. The payment method used by the merchant is updated 73 if needed. For example, if merchant begins using a new payment method (method 3 or 4), this payment method is added to the database for this merchant. An example of this can be seen in FIG. 6, table 60, where method 4 (token based mobile payment) is added to merchant of Card Acceptor Identification Code=c, merchant terminal of Card Acceptor Terminal Identification=d. The payment method used by this card number is updated 74 if needed. For example, if the card number starts using a new payment method, then this payment method is added for this PAN in database 56. This example can be seen in FIG. 6, table 63, where payment method 4 (token based mobile payment) is added to card number of PAN=m. Next, the authorization request 18 is checked 75 to see if an old payment method is currently used. If NO, then the transaction can proceed; otherwise, if YES, then continues next step. In case of YES (i.e. an old payment method is currently used), the authorization request is checked 76 to determine if the merchant previously used a new payment method. If NO, then the transaction can proceed; otherwise, if YES, then continues next step. A YES can be seen in FIG. 6 after Step 6 of FIG. 5 in table 64, where fallback to an old payment method (manually entering card number) is detected on the merchant of Card Acceptor Identification Code=c, merchant terminal of Card Acceptor Terminal Identification=d, i.e. answer=YES. The authorization request is checked 77 to determine if the card number previously used a new payment method. If NO, then the transaction can proceed; otherwise, if YES, then continues next step. A YES can be seen in FIG. 6, table 65, where fallback to an old payment method (manually entering card number) is detected on the card of PAN=m, i.e. answer=YES. An alert for this transaction 78 is issued at this point because an old payment method was used in a transaction where a card number is capable of a new payment method and a merchant is capable of accepting a new payment method. When the Issuing Bank detects the above event, it can immediately reject the authorization request or trigger more authentication, e.g. two-factor authentication, etc.

The flow chart in FIG. 7 can be applicable for a behavior change of payment method. One example can be a change from token based mobile payment (method 4) to EMV IC card at POS payment method (method 3), where the new payment method can mean token based mobile payment and old payment method mean EMV IC card at POS payment method (Method 3). However, instead of rejection of this transaction, Issuing Bank can request more authentication, e.g. two-factor authentication.

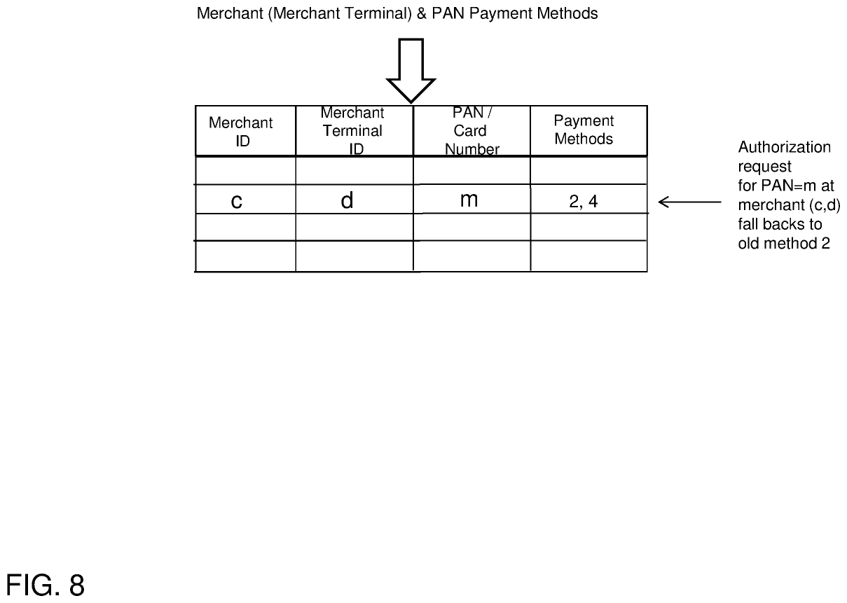

FIGS. 5 and 6 show examples of payment tracking methods used by a particular merchant for any card and payment methods of a particular card number at any merchant. Alternatively, payment tracking methods check a particular card at a particular merchant. FIG. 8 shows an example of a database to store records for the payment methods of a given pair of card number and the merchant. In FIG. 8, an alert can be triggered when the transaction of PAN=m at the merchant Id (CAIC)=c and terminal Id (CATI)=d falls back to old payment method of manually entering card number (method 2) although PAN=m at the merchant Id (CAIC)=c and terminal Id (CATI)=d used new payment method of token based mobile payment (method 4) before. To prevent a false alarm when the user tentatively changes to old mobile payment, the Issuing Bank may reject authorization request after this card number has fallen back to the old payment methods in multiple transactions. Furthermore, to prevent false alarm when the merchant tentatively suspends new payment method due to maintenance reason. Issuing Bank may stop to reject authorization request if authorization request messages consistently falls back to the old payment method for different card numbers at the same merchant.

Thus, by using fraud prevention system 50 in payment system 10, an issuing bank 30 can employ stored and received data collected from authorization requests regarding the payment method available to the customer and payment method available to merchant 14 to determine suspect transactions. A customer that typically uses an EMV card or mobile payment, that uncharacteristically uses an old method payment at a merchant capable of accepting the EMV card or mobile payment, is a suspect transaction and triggers an alert. Only if the merchant does not accept the EMV card or the mobile payment method will old method payments not be suspect.

Various changes and modifications to the embodiments herein chosen for purposes of illustration will readily occur to those skilled in the art. To the extent that such modifications and variations do not depart from the spirit of the invention, they are intended to be included within the scope thereof, which is assessed only by a fair interpretation of the following claims.

Having fully described the invention in such clear and concise terms as to enable those skilled in the art to understand and practice the same, the invention claimed is:

1. A payment system comprising:
a payment device coupled through a merchant to a payment network;
a fraud prevention system coupling an issuing bank to the payment network, the fraud prevention system comprising:
a transaction processing module receiving transaction messages from the payment network and sending messages to the payment network from the issuing bank and providing transaction processing to approve or reject transactions;
a monitor/detect module coupled between the transaction module and a database module storing payment method data; and
a non-transitory computer-readable storage medium having instructions that when effectuated by the monitor/detect module result in the monitor/detect module comparing established payment precedent of parties to a transaction to detect anomalies indicating fraud and sending feedback to the transaction processing module.

2. A payment system as claimed in claim 1 wherein the anomalies include a merchant being able to accept new payment methods and a customer being able to use the new payment methods for a specific card number, but the transaction employs an old payment method as determined by the monitor/detect module effectuating the instructions from the non-transitory computer-readable storage medium.

3. A payment system as claimed in claim 1 wherein the fraud prevention system further comprises:
an alert module coupled to the database module and the monitor/detect module and couplable to a web browsing capable device for sending an alert message thereto; and
a configure module coupled to the database module accessible by a cardholder to enable the alert module to send the alert message when the feedback is a transaction rejection.

4. A payment system as claimed in claim 1 wherein the payment device is one of a card reader, a mobile device and a PC.

5. A card payment method with fraud detection comprising the steps of:
providing a payment device coupled through a merchant to a payment network;
providing a fraud prevention system coupling an issuing bank to the payment network, the fraud prevention system including a database storing payment methods accepted by the merchant, a monitor/detect module coupled between a transaction module and the database module and a non-transitory computer-readable storage medium having instructions that when effectuated by the monitor/detect module result in the monitor/detect module comparing established payment precedent of parties to a transaction to detect anomalies indicating fraud and sending feedback to the transaction processing module;
providing a payment card capable of both old payment methods and new payment methods;
making a payment transaction with the payment card using the payment device and a payment method, the payment method being one of an old payment method and a new payment method;
sending an authorization request message from the payment device to the payment network, the authorization request message including information on the payment method;
forwarding the authorization request message from the payment network to the fraud prevention system of the issuing bank; and
effectuating the instruction carried by the non-transitory computer-readable storage medium with the monitor/detect module, including comparing the payment method used in the payment transaction to the payment methods accepted by the merchant; and sending an authorization response to the payment network, the authorization response being one of an approval and a rejection, an approval when the payment method used in the payment transaction is a new payment method, an approval when the payment method used in the payment transaction is an old payment method and the merchant does not accept a new payment method supported by the payment card, and a rejection if the payment method is an old payment message and the merchant accepts a new payment method supported by the payment card.

6. A card payment method with fraud detection as claimed in claim 5 wherein the step of providing a fraud prevention system includes:
providing a transaction processing module receiving transaction messages from the payment network and sending messages to the payment network from the issuing bank and providing transaction processing to approve or reject transactions; and
providing the monitor/detect module coupled between the transaction module and the database module storing payment method data for comparing established payment precedent of parties to a transaction to detect fraud and sending feedback to the transaction processing module.

7. A card payment method with fraud detection as claimed in claim 6 wherein the step of providing a fraud prevention system further includes:
providing an alert module coupled to the database module and the monitor/detect module and couplable to a web browsing capable device; and
providing a configure module coupled to the database module accessible by a cardholder to enable the alert module to send the alert message when the feedback is a transaction rejection.
